(19) United States
(12) Patent Application Publication
(10) Pub. No.: US 2007/0200266 A1
(43) Pub. Date: Aug. 30, 2007

(54) Method For Producing A Cross-Linked Pvc Foam Body

(76) Inventor: Marcel Elser, Sins (CH)

Correspondence Address: BACHMAN & LAPOINTE, P.C., 900 CHAPEL STREET, SUITE 1201, NEW HAVEN, CT, 06510, US

(21) Appl. No.: 10/592,103

(22) PCT Filed: Mar. 3, 2005
(86) PCT No.: PCT/EP05/02234

§ 371 Date: Sep. 7, 2006

(30) Foreign Application Priority Data
Mar. 23, 2004 (EP) 04405178.7

(51) Int. Cl. B29C 44/02

(52) U.S. Cl. 264/54

(57) ABSTRACT

A method for producing a cross-linked PVC rigid-foam body from a starting mixture containing PVC, an isocyanate or polyisocyanate, an organic anhydride and a chemical expanding agent by: converting the starting mixture into a molded article inside a compacting device under the action of pressure and heat; removing the article from the mold, and; expanding and hardening the obtained molded article in an expanding device while supplying heat and water and/or water vapor whereby forming a cross-linked PVC foam body. The starting mixture contains epoxidized compounds in amounts greater than 3% by weight, preferably greater than 5% by weight, and less than 15% by weight with regard to the starting mixture.

### CROSS REFERENCE TO RELATED APPLICATIONS

This case is the U.S. national phase of International Application No. PCT/EP2005/002234 filed Mar. 3, 2005 which claims priority of European Application No. 04405178.7 filed Mar. 23, 2004.

### BACKGROUND OF THE INVENTION

The invention relates to a method for producing a foam-body from PVC and a foam-body and the use thereof.

Polyvinylchloride (PVC) is often employed in the production of foamed items. Thereby, one differentiates between soft and rigid PVC foams. The soft PVC foams usually contain softeners. They find application typically in mats for gymnastics or as floating aids.

In the case of rigid PVC foamed-bodies which are used e.g. as layers in sandwich-materials, one differentiates between linear PVC foams which are not cross-linked and the so called cross-linked PVC foams which—as a result of a cross-linking reaction—yield a harder but also more brittle foam bodies.

There are various known methods for producing cross-linked rigid foams with an essentially closed cell structure. A common method which has been in use in industry for a long time, was developed by the French company “Kleber Colombes”, and is described in the patent publication FR 1 366 979. Using that method a polyisocyanate, an unsaturated acidic anhydride and a monomer such as styrene are specified as components of the cross-linked structure. By the reaction of isocyanate with water and further starting constituents, a polymer network is formed which stiffens the PVC foam body. It is assumed that the PVC itself is part of this polymer network.

A proven method for manufacturing such cross-linked PVC rigid foams is based on a discontinuous process which takes place in at least three stages.

In a first stage of the process a starting mixture in the form of a PVC-plastisol is produced from at least four starting components. The first component, and at the same time, the main constituent of the starting mixture is PVC itself which is present in powder form. The second component is an isocyanate or poly-isocyanate. The third component is an acidic anhydride. By the reaction of the second and third components with water the said network is formed, at the same time forming gaseous CO₂. The fourth component is a chemical propell-ant which releases a gas during thermal decomposition. As a rule this is azo-butyronitril to iso-butronitril or azo-dicarbonamide, whereby in this case the gas released is N₂.

In some cases the starting mixture contains further components such as stabilisers or solvents.

At least one component should be in liquid form in order for it to be at all possible to produce a homogeneous starting mixture which enables a foam to be produced with a uniform cell structure. As a rule the isocyanate or the poly-isocyanate is in liquid form and gives the stating mixture a pasty to runny condition.

In a second stage of the process the starting mixture is melted in a gas-tight compacting device or in an overlapping edge tool at a temperature of 150 200° C. under a pressure of 5-500 bar. Under these conditions the chemical propellant of the starting material is decomposed, whereby the resultant gas creates the small initial bubbles (also called embryonic bubbles). At the same time the PVC gels with increasing viscosity until the plastic mass sets as a moulded article.

On addition of water or water vapour, and under the influence of heat, the solidified moulded article is cross-linked to a rigid PVC foam in the third stage of the process, whereby the moulded article—under the influence of the gases created by the chemical propellant and due to the release of CO₂—expands to a rigid foam.

The foam-body may be subjected to a further hardening in a subsequent tempering oven, in which the rest of the isocyanate is converted. The tempering preferably takes place in a moist atmosphere at a maximum temperature of 70° C. Depending on the thickness of the panel, this may require 2 to 25 days.

The PVC foams produced using the starting components known to date and using the conventional three-stage process, exhibit high compressive strength and rigidity and also a high degree of stability, and are particularly suitable in structural applications involving static loads e.g. in composite components, in particular as core layers in sandwich-type elements. In contrast to linear i.e. non-cross-linked PVC foams, cross-linked PVC rigid foams are considerably harder.

The mentioned foams are, however, also more brittle and the impact strength or resistance to rupture of such cross-linked PVC foams made according by state-of-the-art methods is not satisfactory for certain applications involving dynamic loading. For example, PVC rigid foams are employed in composite elements for structural applications in shipbuilding and marine use. The requirement made of such composite elements is that the foam core is tolerant to damage and on impact resists structural failure (in particular failure due to shear in the core) this, in order that damage—and in particular subsequent damage—can be kept within limits under collision. Linear core materials which exhibit high elongation on failure are particularly well suited for such applications.

The object of the present invention is therefore to propose an isocyanate-cross-linked PVC foam exhibiting tolerance to damage and high elongation on failure, which can be produced using the discontinuous three-stage process described above.

### SUMMARY OF THE INVENTION

That objective is achieved by way of the invention as described by providing a method for manufacturing a cross-linked PVC rigid foam from a starting mixture containing PVC, an isocyanate or polyisocyanate, an organic anhydride and a chemical propellant, by converting the starting mixture to a moulded article under the influence of pressure and heat in a compacting device, removing, expanding and hardening the moulded article in an expansion device accompanied by the supply of heat and water and/or water vapour into a cross-linked ÜPVC foam body, characterised in that, the starting mixture contains epoxidized compounds in amounts of more than 3 wt. % with reference to the starting mixture.

The core of the invention is that additional epoxidised compounds are added in minimal amounts to the generally known starting components. Epoxidised com-pounds such as e.g. epoxidised plant oils, are in fact known as co-stabilisers for PVC, and are as such added in amounts of e.g. 0.5 to 1.5% by weight of the starting mixture. The addition of epoxidized compounds in much greater amounts, in order to increase the ductility on rupture or deformation on failure was, however, not known up to now.

High-molecular epoxidized compounds, which are preferably are added in liquid form, function as long chain cross-linking agents. In contrast i.e. as compensat-ion, in a preferred version of the invention the fraction of isocyanates or poly-isocyanates in the starting mixture which produces short chain cross-linking is correspondingly reduced in comparison with state-of-the-art methods. By add-ing epoxidized compounds an overall reduction in the degree of cross-linking, i.e. a wide meshed cross-linking of the foam is achieved in that, in the course of the cross-linking reaction, the epoxidized compounds are incorporated in the network as long chain components.

### BRIEF DESCRIPTION OF THE DRAWINGS

In the following the invention is explained in greater detail by way of examples and with reference to the accompanying drawing which shows in:

FIG. 1: the schematic representation of a three-stage, discontinuous process for producing a PVC foam body according to the invention;

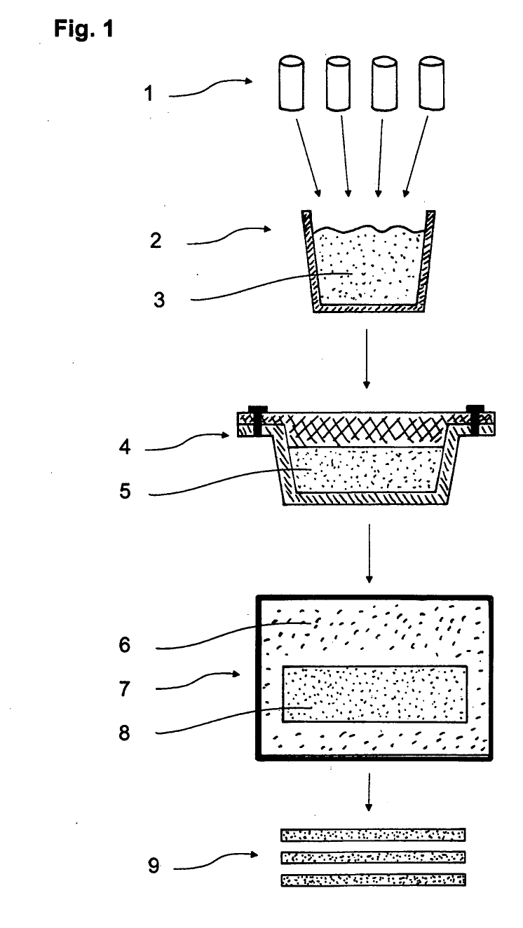

FIG. 2a-c: comparison of the mechanical properties of different, closed-cell PVC foams;

FIG. 3a-c: comparison of the mechanical properties of different, closed-cell PVC foams;

FIG. 4: comparison of the compressive strength of different, closed-cell PVC foams;

FIG. 5: sandwich panels with different foam cores after a falling dart impact test.

### DETAILED DESCRIPTION

In the preferred version of the invention the epoxidized compounds are also present in liquid form; it is, therefore, possible in some cases to dispense with additional solvents in spite of reducing the amount of isocyanate.

The starting components for producing the starting mixture according to the invention which is capable of flow comprise in particular:
a) a PVC in powder form;
b) an isocyanate as cross-linking agent;
c) a chemical and partially additional physical propellant;
d) an organic anhydride, in particular an aromatic or olefinic unsaturated anhydride as additional cross-linking agent, and
e) epoxidized compounds.

The PVC is preferably in a form in which it can be added to the starting mixture as uniformly as possible. The PVC is therefore advantageously in a dry-pourable form e.g. as a powder, in particular extremely fine powder.

The amount of PVC present is e.g. 20-95 wt. %, preferably 30-70 wt. %, advantageously 40-60 wt. %, in particular 45-55 wt. % with reference to the starting mixture.

The isocyanate may be a poly-isocyanate or a diisocyanate, such as 2.4 or 2.6 toluene diisocyanate (TDI), 4,4′-diphenylmethane-diisocyanate (MDI, such as e.g. Desmodur® 1520 A20) or hexamethylene-diisocyanate (HDI or HMDI), iso-phoron-diisocyanate (IPDI) a triisocyanate, such as p,p′,p″-triphenyl-methylene-triisocyanate or a poly-isocyanate, such as poly-methylene-polyphenyl-isocyanate or mixtures of two or more thereof. Polyisocyanates which are preferred within the scope of the invention are the aromatic diisocyanates.

The isocyanate is on the one hand, along with the acetic anhydride, an important constituent of the polymer network. On the other hand the isocyanate also acts as a propellant in that the reaction of isocyanate with H₂O or carbonic acid from the anhydride causes CO₂ to be released, which supports the formation of cells in the foam.

The isocyanate is preferably in liquid form, which make it possible at all to produce a starting mixture capable of flow, in particular a starting mixture of pasty consistency.

The fraction of isocyanate is reduced, in comparison with the state-of-the-art average amounts, by the addition of epoxidized compounds in amounts per 100 parts PVC (referring to weight) usefully to more than 20, advantageously more than 25, in particular more than 30 and usefully less than 65, preferably less than 60, advantageously less than 55, in particular less than 50. In a particularly preferred version of the invention the fraction lies around 35 to 45 parts epoxidised compounds per 100 parts PVC by weight.

The fraction of isocyanate in wt. % of the starting mixture usefully amounts to 0.5 preferably more than 5, advantageously more than 10, in particular more than 15 and usefully less than 50, preferably less than 40, in particular less than 30. In a particularly preferred version the fraction at around 20-30 wt. %, in particular around 17-23 wt. %.

The propellant is preferably a chemical propellant, in particular an azotized propellant. Azotized propellants are compounds which break down irreversibly under the influence of heat, whereby at temperatures of 80-200° C. nitrogen (N₂) is given off. Such compounds may be azotised compounds such as e.g. azodicarbonamide, azo-di-isobutyronitril, or N-Nitroso-compounds, such as N,N′-dinitrosoterephthamide or N,N′-dinitrosopentamethylene tetramine and sulphonylhydrazides such as benzenesylphonylhydrazide or benzene-1,3-disulphonylhydrazide.

Preferred are azo-di-isobutyronitril (AIBN/AZDN), genitron®), azodicarbonamide (Unifoam AZ) or mixtures thereof, in particular a mixture of azo-di-isobutyro-nitril and azodicarbonamide. Physical propellants may be e.g. toluol, acetone, hexane or trichlorethylene.

The starting mixture may contain as starting component © one or more chemical and/or physical propellants.

The starting component © is, depending on the bulk density of the foam body aimed for, added in total in amounts of 0.1-12 wt. % (weight %), preferably 1-8 wt. %, in particular from 2-6 wt. % of the starting mixture.

The organic (acidic) anhydride may be based on one or more basic carbonic acids. The organic anhydride may e.g. be phthalic-acid-anhydride (PSA phthalic anhydrides), maleic-acid-anhydride (maleic-anhydride), succinic-acidic-anhyd-ride (succinic-anhydride), cinnamic acid, citric-acid-anhydride, itaconic-acid-anhydride, trimellite-acid-anhydride (TMA, trimellite anhydride), hexahydro-phthalic-acid-anhydride (HHPA, hexahydro-phthalic-anhydride), methylhexa-hydrophthalic-acid-anhydride (MHHPA, methylhexa-hydrophthalic-anhydride), cyclohexane-1,2-dicarbonicacid-anhydride (cyclohexane-1,2-dicarboxylic anhyd-ride), cis-cyclohexane-1,2-dicarbonicacid-anhydride (cis-cyclohexane-1,2-di-carboxylic-anhydride), trans-cyclohexane-1,2-dicarbonic-acid anhydride (trans-cyclohexane-1,2-dicarboxylic-anhydride) or a mixture of two or more of the mentioned anhydrides.

The anhydrides form, together with the isocyanate, a network in that as a result of chemical reactions in which the anhydrides participate, water and iso-cyanate amides are produced as network-forming agents.

A higher degree of cross-linking is, therefore, achieved by the addition of an-hydrides. Also, because of the hydrophilic properties of the added anhydrides, the diffusion of water into the moulded articles is easier, as a result of which the reaction between water and isocyanate is accelerated and initiated through-out. The acid in the anhydride reacts with the epoxidized compounds i.e. the anhydrides serve on the one hand as network-forming agents and also as hardeners for the epoxidized compounds.

As the epoxidized compounds are not only hardened by the amines, but also by organic acids (acid curing agent) such as phthalic acid anhydride or maleic acid anhydride, the role of the organic anhydrides in the incorporation of the epoxidized compounds in the network becomes extremely important.

The fraction of organic anhydride in % by weight of the starting material amounts e.g. to 0-30 wt. %, in particular 2-wt. %. In fractions per 100 parts PVC (with reference to the mass weight) this is e.g. 0-50, in particular 15-25.

The epoxidized compounds are preferably in a form that enables them to flow, in particular in liquid form. Suitable epoxidized compounds are e.g. epoxidized triglycerides, alkylepoxystearates, phthalates or tetrahydrophthalates. In a preferred version the epoxidized compounds contain epoxy groups containing epoxidizes oils, in particular epoxidized plant or animal oils, such as epoxidized soya-bean oils (EPSO), tall oil or linseed oil (EPLO). The oils are preferably unsaturated oils. The epoxidized compounds are preferably made up of one of the above mentioned oils or a mixture of several of these oils.

The epoxidized compounds may also contain or comprise a mixture of epoxy resins and epoxidized oils of the kind mentioned above.

In contrast to the epoxy resins, the epoxidized plant oils are characterised in that as a rule they form less dense networks than the epoxy resins, for which reason epoxidized plant oils are especially preferred. That plant oils are a renewable resource is, from the ecological standpoint, an additional advant-age.

The epoxidized compounds serve not only as agents promoting long chain networks, as mentioned above, but also at the same time as stabilisers, with the result that the use of additional stabilisers is unnecessary.

The fraction of epoxidized compounds per 100 parts PVC (with reference to mass weight) is usefully more than 2, preferably more than 5, advantageously more than 8, in particular more than 11 and usefully less than 30, preferably less than 25, advantageously less than 22, in particular less than 18. In a preferred version the fraction lies around 6 to 10 wt. %.

The starting mixture may in some cases contain further additives such as:
filler materials e.g. calcium carbonate, fine SiO₂ or magnesium oxide,
flame-retardent substances e.g. antimony trioxide
stabilisers e.g. silicates, in particular an Al-silicate, lead-(sulphate, phthalate, phosphite), rhodiastab 50, Ca/Zn stearate, betadiacetone-Ca/Zn-stearate, butyl-tin-mercaptides/carboxylates,
solvents, such as halogenised alkanes, toluol, acetone, hexane, cyclohexanol, tetrapropylbenzene, trichlorethylene or a mixture of these solvents, and
colouring agents or pigments.

Further, the starting mixture may contain co-polymerisible or polymerisible compounds, such as vinylidenmonomers and vinylmonomers e.g. styrene, acrylnitrile, vinyl-acetate, acrylates and methacrylates of saturated primary alcohols with up to 4 carbon atoms, such as methyl-methacrylate.

As the epoxidized compounds added already have the effect of stabilisers, additional stabilisers are as a rule not necessary.

Also, the starting mixture may in addition contain neucleants which act as neuclei for the gas bubbles on forming the cell structure, as a result of which the formation of a uniform, homogeneous distribution of cells is promoted. The neucleants may be finely divided solid particles in the form of an inert material (inert particles). The inert materials may e.g. be porous particles which the freed gas of the propellant take up before forming the actual cells. Suitable inert materials are fine silicas, silicates or glass powder.

The starting mixture produced from the above mentioned starting materials is preferably in the form of a mass capable of flow, in particular a pasty mass, also known as PVC plastisol.

A characteristic starting mixture is made up of the following components and amounts:

| | | Wt. % of |
|---|---|---|
| | | starting mixture |
| (a) | polyvinylchloride (PVC) in powder form | 35-65 |
| (b) | isocyanate such as MDI isocyanate | 15-55 |
| (c) | epoxidized plant oil such as epoxidized soya oil | 1-20 |
| (d) | epoxy resin (e.g. Araldite ®) | 0-7 |
| (e) | solvent, such as acetone | 0-15 |
| (f) | azo-bis-isobutyronitrile (e.g. Genitron ®) | 0.5-4 |
| (g) | azodicarbonamide (e.g. Unifoam AZ) | 1-3 |
| (h) | phthalic acid anhydride | 2-8 |
| (i) | maleic acid anhydride | 0-8 |
| (j) | stabilisors such as Al-silicate | 0-2 |
| (k) | filler material, such as calcium carbonate | 0-8 |

A first suitable starting mixture is made up of the following components:

| | | | Wt. |
|---|---|---|---|
| | | Wt. % of | fraction/ |
| | | starting | 100 part; |
| | | mixture | PVC |
| (a) | polyvinylchloride (PVC) in | 53.8 | 100 |
| (b) | powder form | 24.2 | 45 |
| (c) | MDI isocyanate | 6.6 | 12 |
| (d) | epoxidized soya oil | 1.6 | 3 |
| (e) | epoxy resin (Araldite ®) | 4.3 | 8 |
| (f) | acetone | 2.4 | 4.5 |
| (g) | azo-bis-isobutyronitrile | 1.2 | 2.25 |
| (h) | (Genitron ®) | 5.9 | 11 |
| | azodicarbonamide (Unifoam AZ) | | |
| | phthalic acid anhydride | | |

A second suitable starting mixture is made up of the following components:

| | | | Wt. |
|---|---|---|---|
| | | Wt. % of | fraction/ |
| | | starting | 100 part; |
| | | mixture | PVC |
| (a) | polyvinylchloride (PVC) in | 53.8 | 100 |
| (b) | powder form | 24.2 | 45 |
| (c) | MDI isocyanate | 6.6 | 12 |
| (d) | epoxidized soya oil | 1.6 | 3 |
| (e) | epoxy resin (Araldite ®) | 4.3 | 8 |
| (f) | acetone | 2.4 | 4.5 |
| (g) | azo-bis-isobutyronitrile | 1.2 | 2.25 |
| (h) | (Genitron ®) | 3.8 | 7 |
| (i) | azodicarbonamide (Unifoam AZ) | 2.1 | 4 |
| | phthalic acid anhydride | | |
| | maleic acid anhydride | | |

In the production of the starting mixture the liquid components (b), (c), (d) and (e) are preferably prepared first then, preferably accompanied by stirring, the solids (f), (g), (h) and if desired (i) mixed in together. After that the PVC powder (a) is mixed in.

For the production of a PVC rigid foam the liquid starting mixture is placed in a compression device, preferably in the cavity of a sealed i.e. gas-tight mould. The mould may e.g. be an injection moulding tool with vertical flash faces (German: Tauchkantenwerkzeug). The starting mixture is heated e.g. to a temperature of 150-200° C., in particular 160-190° C. at a pressure of 5-500 bar, in particular 100-300 bar. Already at a temperature of 70° C. the chemical propellants begin to decompose forming gas (nitrogen); at a temperature of around 150° C.—due to the gelling of the PVC, accompanied by an increase in the viscosity—the plastic mass is transferred from a flowable state to a solid state.

The high pressure of around 150 bar is a result of the decomposition of the propellant. However, in order that the flowable starting mixture does not already expand fully in the mould, this pressure must be maintained, essentially until the starting material has cooled and solidified a rubber-elastic moulded article.

The decomposition of the propellant under pressure causes the formation of extremely initial bubbles in which the gas is trapped. The high pressure, however, suppresses complete expansion of the bubbles in the starting material which has not yet solidified. At this stage of the process, however, no significant chemical cross-linking has taken place between the individual components.

In a subsequent step the plastic mass is cooled and solidifies as a block-shaped, rubber-elastic moulded article. When the moulded article has reached an adequate degree of solidification, the pressure can be steadily reduced until atmospheric pressure is reached.

In a specific version of the process the, by carrying out a defined degree of opening during the reduction of pressure, it is possible to create a brief reduction in pressure which causes uniformly distributed bubbles to form in the plastic mass which has not yet completely solidified, this without the plastic mass expanding to any significant degree. The uniform creation of small initial bubbles induced by this step in the process is the basis for producing a foam body with a uniform, fine cell structure.

After the moulded article has solidified adequately, and the reduction in pressure and cooling has been completed, the moulded article is removed from the mould. This is then in the form of a flat or block-shaped flexible body with rubber-elastic properties, which are a result of the non-cross-linked state of the plastic mix.

In a subsequent process step, as a result of providing heat and H₂0, the moulded article is transformed into a cross-linked PVC rigid foam due to the cross-linking reaction and simultaneous expansion. The H₂0 may be provided in liquid and/or vapour form. It is preferably fed heated to a temperature e.g. of 70-100° C., in particular 95-100° C. The expansion step is preferably carried out in an expansion oven in which the H₂0 for the cross-linking reaction is supplied in the form of water vapour.

For the expansion and hardening process, the moulded article may however also be introduced into a water bath in which the water temperature is e.g. over 70° C. In a specific version of the invention glycol is added to the water in order to operate at higher process temperatures.

As mentioned above, the supply of H₂0 causes the above mentioned cross-linking step to be started, whereby in a first reaction H₂0 reacts with the isocyanate groups, forming amines and free C0₂:
R—NCO+H₂0→RNH₂+C0₂

The C0₂ released acts as additional propellant.

Under the influence of heat in the expansion oven which leads to softening of the moulded article, the gases in the initial bubbles, together with the C0₂ released in the above reaction, starts the expansion of the moulded article to a foam body. The C0₂ is thereby the main propellant contributing to expansion, while the chemical is of decisive importance with regard to the formation of the small initial bubbles. In the expansion stage cell growth starts from these small initial bubbles. The small initial bubbles are therefore decisive in regard to the number, size and distribution of cells in the expanded foam body.

In further chemical reactions with the anhydrides, or the acids formed by them, the amines form cross-linking amide bridges.

During this process the epoxidized compounds react with the isocyanate in the network whereby, longer chains of molecules are formed by the use of epoxidized compounds, as a result of which the degree of cross-linking can be kept to a lower level. As a result, the ductility of the foam under impact increases and the brittleness desreases without the foam losing compressive strength and rigidity to any significant degree.

The expansion of the moulded article may also take place at atmospheric pressure or at pressures approaching atmospheric pressure.

The moulded article may also expand freely in the expansion oven or, with a view to further expansion, be clamped in a mould or mould frame having the defined dimensions of the final product.

In a final step the expanded foam body may be tempered in a tempering oven at elevated temperature. Thereby, the core parts of the foam body are cross-linked further. Furthermore, water or water vapour may be supplied during the tempering process.

The rigid foam bodies according to the invention exhibit an essentially closed cell structure with essentially uniform distribution of cells. The elongation of the foam material at fracture under shear conditions is preferabl 35% or more, in particular 40% or more, and especially advantageously 45% or more.

The process is to advantage carried out in such a manner that the small bubbles or cells are isotropic in form so that the foam body exhibits isotropic mechanical and physical properties. It is, however, also possible for the expan-sion of the moulded article to be carried out in a preferred direction so that anisotropic cells are formed, endowing the foam body with anisotropic mech-anical and physical properties.

The described discontinuous, three stage process and the device employed to carry out the process make it possible to produce solid, large format foam bodies according to the invention. In contrast to other PVC foam bodies with comparable mechanical properties, the PVC foam bodies according to the invention can, thanks to their special starting mixture of epoxidized compounds, be produced as described above using the known three stage, discontinuous process. Additional development costs for implementing a new process with appropriate, new production equipment to process the starting material accord-ing to the invention are eliminated to a very high degree.

The hardened and expanded PVC foam bodies are preferably in the form of panel or block-shaped bodies and exhibit dimensions of length and width of e.g. 50-500 cm, preferably 100-300 cm and thickness of around 1-100 cm, preferably 3-50 cm. The dimensions (width, length, thickness) of a typical PVC rigid foam body are 120×240×20 cm.

The hardened and expanded PVC rigid foam bodies may be made e.g. in the form of light-weight foam with a gross density of 30-200 kg/m³ or as heavy foam with a gross density of over 200 kg/m³.

At a gross density of 130 kg/m³ or more, no solvent or only small amount thereof, is added according to the state-of-the-art. In order to achieve gross density values of less than 130 kg/m³, it is preferable to add solvent.

In subsequent process steps the finished, preferably panel-shaped or block-shaped bodies are preferably cut to panels of specific size which then allows them to be used in the production of composite laminates. The material can also be accurately bored, sawed, planed and (under the influence of heat) shape-formed.

The foam bodies according to the invention find application in particular in vehicle manufacture, such as road-bound or rail-bound vehicles, in wind energy converters and in aircraft manufacture. Due to their relatively low gross density, the foam bodies also find application in the shipbuilding industry. Also, the foam bodies according to the invention find application in articles used in recreational activities and sport, or in articles for construction or building purposes.

Specific aplications may be: flooring in vehicles, boots, aircraft; rotor blades of wind energy converters; thermal and/or sound insulation elements; hulls, decks and superstructures in boot and marine construction; wings and dividing walls of aircraft; self-load-bearing bodywork part; deep sea tanks; mine-clearance vehicles; skis and surfboards.

For that purpose, the block-shaped foam bodies manufactured using the process according to the invention are preferably cut into foam panels and passed on in that form for further use or further processing steps. The foam panels may e.g. be laminated on one or both sides with one or more layers to form layers of composite materials. The foam panels are preferably employed as core layers in sandwich-type composite elements. The outer layers may be of metal such as aluminium or plastic panel, in particular fibre-reinforced plastic panels.

A starting mixture 3 according to the invention is manufactured from several starting components in a mixing device 2. The starting mixture 3 is converted in a compacting device 4 to a moulded article 5. The moulded article 5 is prefer-ably flat to block-shaped. The solidified moulded article 5 is removed from the mould and hardened and expanded in an expansion device 7 by addition of heated water and/or water vapour 6 to a cross-linked PVC rigid foam body 8. The PVC rigid foam body may, if desired, be tempered in a tempering oven at elevated temperature i.e. completely hardened (not shown here). The fully hardened rigid foam body may subsequently be processed further and e.g. cut into foam panels 9.

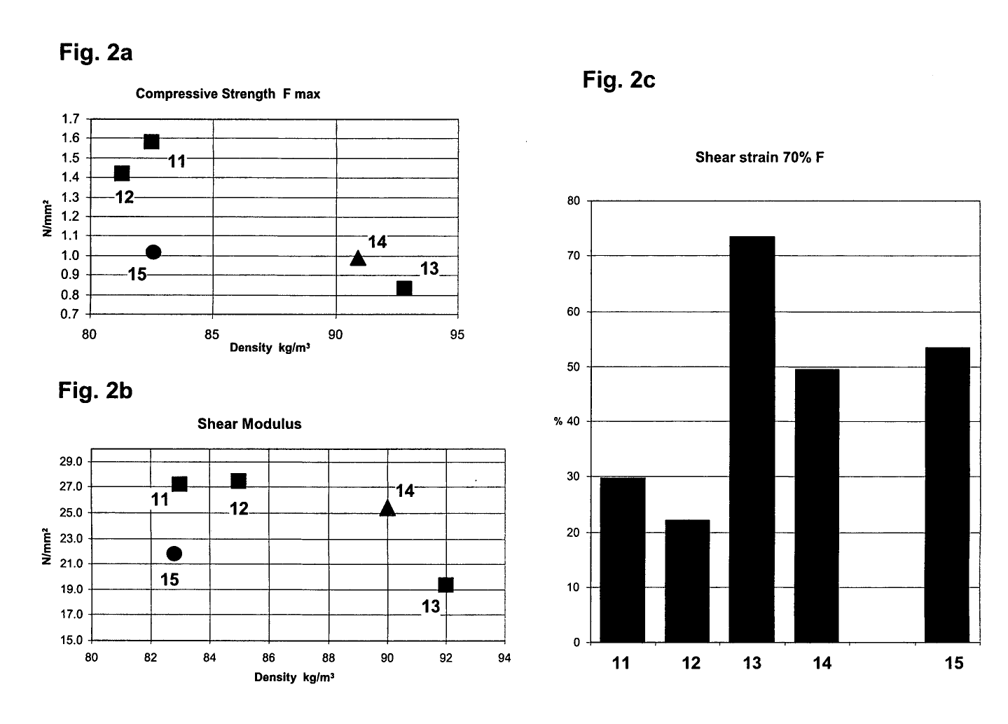

FIGS. 2a to 2c show a comparison of the mechanical properties of various closed-cell foams, whereby 11 is a C71.75 foam (cross-linked PVC rigid foam), 12 is a C70.75 foam (cross-linked PVC rigid foam), 13 is an R63.80 foam (linear PVC foam), 14 is a CoreCell A500 foam (linear polymer-foam) and 15 a PVC rigid foam according to the invention.

The compressive strength Fₘₐₓ in FIG. 2a of the PVC rigid foam according to the invention with a gross density of around 83 kg/m³ lies below the compressive strength of known PVC rigid foams 11, 12 of similar gross density, however, above or in the region of the compressive strength of linear foams 13, 14 of gross density higher than 90 kg/m³.

According to FIG. 2b the shear modulus of the PVC rigid foam 15 according to the invention lies below that of known PVC rigid foams 11, 12; it is however very high in comparison with linear foams 13, 14 of much higher gross density.

Further, as shown in FIG. 2c, the PVC rigid foam 15 according to the invention exhibits a comparatively high shear elasticity compared with cross-linked PVC rigid foams 11, 12.

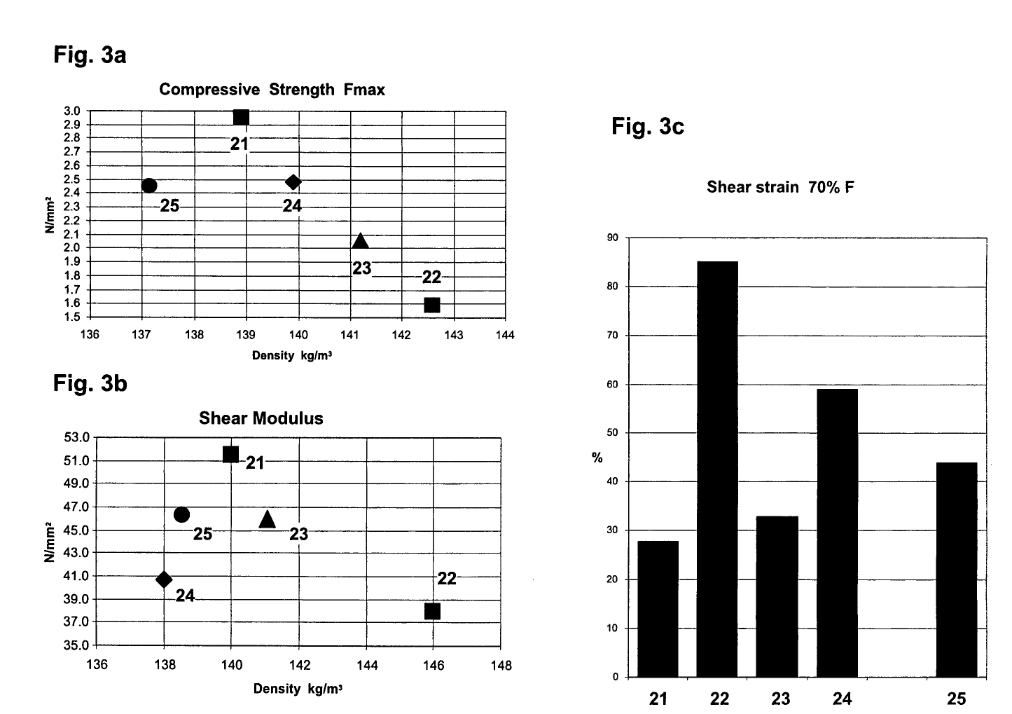

FIGS. 3a to 3c show a comparison of mechanical properties of various closed cell foams, whereby 21 is a C70.130 foam (cross-linked PVC rigid foam), 22 is an R63.140 foam (linear PVC foam), 23 is a CoreCell A800 foam (linear polymer-foam), 24 is a divinylcell HD130 foam (cross-linked PVC rigid foam) and 25 is a PVC rigid foam according to the invention.

In FIG. 3a the compressive strength Fₘₐₓ of the PVC rigid foam 25 according to the invention of gross density of around 137 kg/m³ lies over or in the range of the compressive strength of foams 22, 23 and 24 of higher gross density.

According to FIG. 3b the shear modulus of the PVC rigid foam according to the invention is very compared to that of the linear rigid foams.

Further, according to FIG. 3c the PVC foams 22, 24 with comparably low shear modulus exhibit a high degree of elasticity under shear, while PVC foams 21, 23 with comparably high shear modulus exhibit a low degree of elasticity under shear.

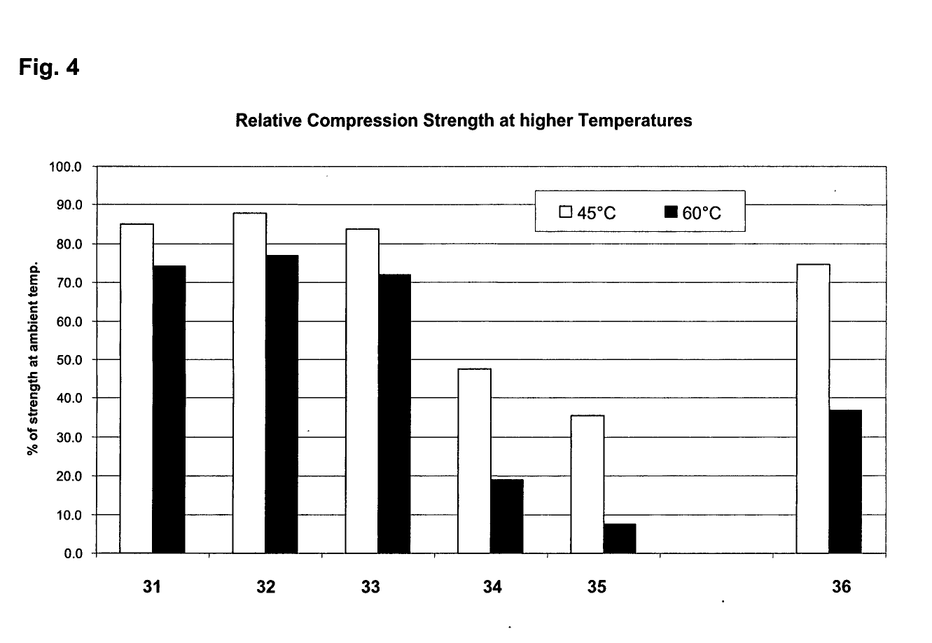

FIG. 4 shows the relative compressive strength of various closed cell foams at 45° C. and 60° C. in direct comparison, whereby 31 is a C70.55 foam (cross-linked PVC rigid foam), 32 is a C71.75 foam (cross-linked PVC rigid foam), 33 is a CoreCell A500 foam (linear polymer-foam), 34 is a divinylcell HD130 foam (cross-linked PVC rigid foam), 35 is an R63.80 foam (linear PVC foam) and 36 is a PVC rigid foam according to the invention. The foam according to the invention exhibits—compared to the PVC rigid foams 34, 35—relatively high compressive strength at elevated temperature.

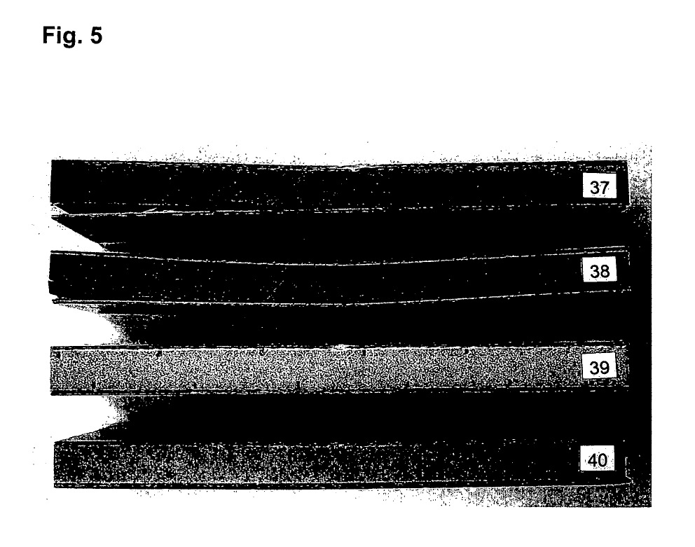

FIG. 5 shows the appearance of sandwich panels after falling dart impact test-ing. In this test 20 mm thick foam samples are laminated on both sides with fibre-glass reinforced polyester and, after curing, cut to size and placed in a free-fall impact testing device. The dimensions of the test pieces are 295×80 mm. The distance between the underlying supports is 210 cm. The hemispher-ical front of the dart has a radius of 35 mm. The weight of the dart is 5,945 g and the free-fall height is 150 cm.

The test pieces in FIG. 5 shows a comparison of test pieces: 37 a C70.75 foam (cross-linked PVC rigid foam), 38 a C70.90 foam (cross-linked PVC rigid foam), 39 an R63.80 foam (linear PVC foam) and 40 a PVC rigid foam according to the invention.

This practical test enables the resistance to damage by a foam to be illustrated in an impressive manner. According to experience the test is regarded as having been passed if an elongation under shear of at least 40% is exhibited.

In the falling dart impact test, the foam 40 according to the invention, as does the linear PVC foam 39, exhibits no significant damage to the outer layers, no signs of delamination and no damage whatsoever to the foam. The harder, but more brittle cross-linked PVC rigid foams 37 and 38, however, exhibit the typical damage for that type of foam viz., through cracks in the core (shear failure in the core) and partial delamination of the bottom outer layer.

1-9. (canceled)

10. Method for manufacturing a cross-linked PVC rigid foam comprising providing a starting mixture containing PVC, an isocyanate or polyisocyanate, an organic anhydride and a chemical propellant; converting the starting mixture to a moulded article under the influence of pressure and heat in a compacting device; removing, expanding and hardening the moulded article in an expansion device accompanied by the supply of heat and water and/or water vapour into a cross-linked ÜPVC foam body, wherein the starting mixture contains epoxidized compounds in amounts of more than 3 wt. % with reference to the starting mixture.

11. Method according to claim 10, wherein the starting mixture contains epoxidized compounds in amounts of more than 5 wt. % with reference to the starting mixture.

12. Method according to claim 10, wherein the starting mixture contains epoxidized compounds in amounts of more than 6 wt. % and less than 20 wt. % with reference to the starting mixture.

13. Method according to claim 10, wherein the starting mixture contains epoxidized compounds in amounts of more than 6 wt. % and less than 15 wt. % with reference to the starting mixture.

14. Method according to claim 10, wherein the starting mixture contains epoxidized compounds in amounts of more than 6 wt. % and less than 11 wt. % with reference to the starting mixture.

15. Method according to claim 10, wherein the epoxidized compounds comprise epoxidized oils.

16. Method according to claim 10, wherein the epoxidized compounds comprise soya bean oil.

17. Method according to claim 10, wherein the epoxidized compounds comprise epoxy resins.

18. Method according to claim 10, wherein the epoxidized compounds comprise Araldite®.

19. Method according to claim 10, wherein the epoxidized compounds comprise epoxidized oils and epoxidized resins.

20. Method according to claim 10, wherein the epoxidized compounds comprise expoxidized soya bean oil and Araldite®.

21. Method according to claim 10, wherein the PVC rigid foam bodies are manufactured in a process comprising the process steps:
(a) production of a starting mixture of at least three starting components;
(b) converting the starting mixture into a moulded article by gelling the PVC under the influence of heat and pressure in a compacting device;
(c) expanding and hardening the moulded article to a cross-linked PVC rigid foam body while supplying heat and water and/or water vapour in an expanding device.

22. Method according to claim 21, wherein in step (b) by thermally induced decomposition of the chemical propellant uniformly distributed small initial bubbles are formed.

23. Cross-linked PVC rigid foam bodies, manufactured in accordance with the method of claim 10.
